(19) United States
(12) Patent Application Publication
(10) Pub. No.: US 2016/0225194 A1
(43) Pub. Date: Aug. 4, 2016

(54) APPARATUS AND METHOD FOR CREATING BLOCK-TYPE STRUCTURE USING SKETCH-BASED USER INTERACTION

(71) Applicant: ELECTRONICS AND TELECOMMUNICATIONS RESEARCH INSTITUTE, Daejeon (KR)

(72) Inventors: Jae-Woo KIM, Daejeon (KR); Kyung-Kyu KANG, Seoul (KR); Dong-Wan RYOO, Daejeon (KR); Ji-Hyung LEE, Daejeon (KR)

(21) Appl. No.: 14/990,377

(22) Filed: Jan. 7, 2016

(30) Foreign Application Priority Data
Jan. 30, 2015 (KR) 10-2015-0015263

(51) Int. Cl. G06T 19/20; G06F 3/0481; G06F 3/0484; G06T 17/20

(52) U.S. Cl. CPC G06T 19/20; G06T 17/20; G06F 3/04815; G06F 3/04842; G06F 3/04845; G06T 2200/24

(57) ABSTRACT

An apparatus and method for creating a block-type structure using sketch-based user interaction. The apparatus for creating a block-type structure includes a voxel modeling unit for modeling a sketch, input via an interface, into a three-dimensional (3D) voxel model, a block-type structure creation unit for modeling the 3D voxel model into a block-type structure into which blocks stored in a block database are assembled, based on the stored blocks, and a control unit for performing feedback for a procedure for modeling the block-type structure, based on the interaction of a user using the interface.

### CROSS REFERENCE TO RELATED APPLICATION

This application claims the benefit of Korean Patent Application No. 10-2015-0015263, filed Jan. 30, 2015, which is hereby incorporated by reference in its entirety into this application.

### BACKGROUND OF THE INVENTION

1. Technical Field

The present invention generally relates to an apparatus and method for creating a block-type structure via sketch-based user interaction.

2. Description of the Related Art

Schemes for assembling block-type structures are broadly divided into two types: one is a scheme for assembling a structure in stages based on a manual, and the other is a scheme for freely assembling a structure having a shape desired by a user.

The scheme for assembling a structure based on a manual is configured to provide a manual in which the structure of a toy is defined in advance and the pieces of the toy are assembled in stages depending on the shape defined in the description or a design drawing, thus allowing the user to assemble block-type pieces with reference to the manual and to complete a block-type structure.

The scheme for assembling a structure having a shape desired by a user is a scheme in which a structure having a shape desired by an individual user is freely designed and constructed without requiring a manual for a previously defined structure.

In order to assemble a structure having a shape desired by a user, a lot of time and effort are required. To complete a structure desired by a user, the structure is completed via trial and error for repeating the assembly and disassembly of the structure using a large number of blocks. However, since preset blocks are used, it may not be guaranteed that the completed structure is the initially intended structure.

To solve this problem, the development of technology for converting a three-dimensional (3D) model into a block-type structure has been attempted. For this, 3D mesh models are mainly used, and methods for creating a structure based on direct modeling using existing 3D modeling software (Maya, 3D Max, Softimage, etc.) or methods for downloading and utilizing a large number of models that are open to the public over the Internet may be used.

Such a conversion technology still remains at a primary level, and merely creates structures having a simplified shape using base blocks having a limited shape. Therefore, the degree of completion of block-type structures created using such technology is lower than that of structures constructed based on manuals.

Such a problem results from automated processing performed using a 3D image processing technique during the procedure for constructing a block-type structure. To create block-type structures having a high degree of completion, blocks having a wider variety of shapes and a wider variety of colors must be used. However, when such factors are taken into consideration, the load required to automatically and simultaneously convert individual portions of a 3D model into a block-type structure using a 3D image processing technique is increased, and thus the required time is excessively increased. Therefore, for efficient optimization, excessive restrictions must be imposed on the types and colors of blocks that can be used. As a result, block-type structures having a low degree of completion are inevitably created.

Therefore, technology for creating block-type structures having a high degree of completion while minimizing restrictions imposed on the types and colors of blocks is urgently required.

### SUMMARY OF THE INVENTION

Accordingly, the present invention has been made keeping in mind the above problems occurring in the prior art, and an object of the present invention is to set a task area, the type of 3D image processing technique, and parameters for the 3D image processing technique via the interaction of a user.

Another object of the present invention is to provide an assembly manual for a block-type structure.

A further object of the present invention is to provide an assembly manual for a video-format block-type structure.

Yet another object of the present invention is to select the area of a block-type structure and select the type of 3D image processing technique differently depending on the area.

Still another object of the present invention is to provide an intuitive interface based on a sketch.

In accordance with an aspect of the present invention to accomplish the above objects, there is provided an apparatus for creating a block-type structure, including a voxel modeling unit for modeling a sketch, input via an interface, into a three-dimensional (3D) voxel model; a block-type structure creation unit for modeling the 3D voxel model into a block-type structure into which blocks stored in a block database are assembled, based on the stored blocks; and a control unit for performing feedback for a procedure for modeling the block-type structure, based on interaction of a user using the interface.

The control unit may include an output unit for rendering the modeled block-type structure and outputting a rendered block-type structure via the interface so as to perform interaction; an area input unit for selecting, via the interface, an area of the block-type structure in which feedback is to be performed, in a sketch mode and transmitting information about the selected area to the block-type structure creation unit; and an image processing method input unit for receiving a type of 3D image processing method to be used for creation of the block-type structure and one or more of parameters for the 3D image processing method, and transmitting the 3D image processing method and the parameters to the block-type structure creation unit.

The interface may display a contour of an area including a part of the block-type structure so that the contour overlaps the block-type structure.

The block-type structure creation unit may include an area setting unit for setting an area in which modeling is to be performed, based on the area selected by the area input unit; an image processing method setting unit for setting an image processing method to be used for modeling, based on the 3D image processing method and the one or more of the parameters, which are received by the image processing method input unit; and a modeling unit for modeling the block-type structure, based on information set by the area setting unit and the image processing method setting unit.

The voxel modeling unit may include an input unit for receiving a model drawn in a sketch mode via the interface; a mesh model generation unit for generating a 3D mesh model based on the model received via the interface, visualizing the mesh model for the user, and modifying the visualized mesh model; and a voxel model generation unit for generating the 3D voxel model based on the modified mesh model.

The apparatus may further include a structure modification unit for modifying the block-type structure based on a model that is additionally input in a sketch mode using the interface on which results of rendering the block-type structure are displayed.

The apparatus may further include an output unit for displaying results of rendering one or more of the 3D voxel model and the block-type structure on the interface.

The apparatus may further include a manual output unit for outputting a manual required to create the block-type structure by assembling the blocks.

The manual output unit may include an analysis unit for analyzing blocks constituting the block-type structure; an assembly sequence generation unit for generating an assembly sequence of the block-type structure depending on results of analysis; and a manual making unit for making a manual based on the assembly sequence.

The manual output unit may include a video output unit for outputting the manual in a video format.

In accordance with another aspect of the present invention to accomplish the above objects, there is provided a method for creating a block-type structure, including modeling a sketch, input via an interface, into a three-dimensional (3D) voxel model; modeling, based on blocks stored in a block database, the 3D voxel model into a block-type structure into which the blocks are assembled; and performing feedback for a procedure for modeling the block-type structure, based on an interaction of a user.

Performing the feedback may include rendering the modeled block-type structure and outputting a rendered block-type structure via the interface so as to perform interaction; receiving and transmitting a type of 3D image processing method to be used for creation of the block-type structure and one or more of parameters for the 3D image processing method; and selecting an area of the block-type structure in which the feedback is to be performed using the 3D image processing method via the interface, and transmitting information about the area.

The interface may display a contour of an area including a part of the block-type structure so that the contour overlaps the block-type structure.

Creating the block-type structure may include setting an area in which modeling is to be performed, based on the selected area; setting a 3D image processing method to be used for modeling, based on the 3D image processing method and the one or more of the parameters which are received; and modeling the block-type structure based on set information.

Modeling the sketch into the 3D voxel model may include receiving a model, drawn in a sketch mode, via the interface; generating a 3D mesh model based on the model received via the interface, and generating the 3D voxel model based on the 3D mesh model.

The method may further include creating the block-type structure by additionally inputting and converting a model in a sketch mode via the interface on which results of rendering the block-type structure are displayed.

Modeling into the 3D voxel model may further include displaying the results of rendering one or more of the 3D voxel model and the block-type structure on the interface.

The method may further include displaying the results of rendering one or more of the 3D voxel model and the block-type structure on the interface,

The method may further include outputting a manual required to create the block-type structure by assembling the blocks.

Outputting the manual may include analyzing blocks constituting the block-type structure; generating an assembly sequence of the block-type structure depending on results of analysis, and making a manual based on the assembly sequence.

Outputting the manual may include outputting the manual in a video format.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for creating a block-type structure using sketch-based user interaction according to an embodiment of the present invention;

FIG. 2 is a block diagram showing an example of the control unit shown in FIG. 1,

FIG. 3 is a block diagram showing an example of the block-type structure creation unit shown in FIG. 1;

FIG. 4 is a block diagram showing an example of the manual output unit shown in FIG. 1;

FIG. 5 is a block diagram showing an example of the voxel modeling unit shown in FIG. 1;

FIG. 6 is a diagram showing the forms of input/output of the apparatus for creating a block-type structure using sketch-based user interaction according to an embodiment of the present invention;

FIG. 7 is an operation flowchart showing a method for creating a block-type structure using sketch-based user interaction according to an embodiment of the present invention;

FIG. 8 is an operation flowchart showing a method for performing feedback for a block-type structure based on the interaction of a user shown in FIG. 7; and

FIG. 9 is an operation flowchart showing a manual generation method performed using the manual output unit shown in FIG. 1.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

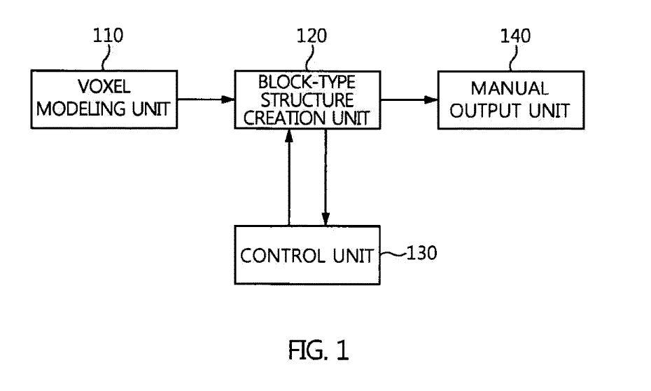

FIG. 1 is a block diagram showing an apparatus for creating a block-type structure using sketch-based user interaction according to an embodiment of the present invention.

Referring to FIG. 1, the apparatus for creating a block-type structure using sketch-based user interaction according to the embodiment of the present invention includes a voxel modeling unit 110, a block-type structure creation unit 120, a manual output unit 140, and a control unit 130.

The voxel modeling unit 110 receives a user's sketch via an interface.

Here, the tool for receiving the user's sketch is not especially limited. For example, the user may personally make a sketch using a touch screen-based interface. Alternatively, the user may make a sketch on two-dimensional (2D) paper, and then the voxel modeling unit may receive the sketch via scanning.

The user may sketch the entirety of a 3D object having a desired shape, or may gradually sketch the object in stages. For example, when a simple object is sketched, the entire object may be sketched at one time and may be recognized. In contrast, when a complicated object is sketched, the entire object may be divided into several unit partitions and the respective partitions may be sketched one by one in stages.

Here, the voxel modeling unit 110 may recognize 2D information generated by the user sketching the object, and may convert a model in 3D space into a 3D mesh model.

Here, when a complicated object is divided into several partitions and respective partitions are sketched, the partitions may be modeled into respective 3D mesh models and the 3D mesh models may be matched with each other, thus enabling a single 3D model to be generated.

The 3D mesh model obtained via modeling may be rendered and may be displayed to the user via a user interface. In this case, the user may modify the 3D mesh model generated based on the sketch via the user interface.

The voxel modeling unit 110 generates a voxel model based on the 3D mesh model. The reason for this is that the inside of the block-type structure is also composed of blocks, and then the block-type structure creation unit 120 must also model the inside of the block-type structure. In this case, the method for generating the voxel model based on the 3D mesh model is not especially limited.

The block-type structure creation unit 120 models the voxel model in a block-type structure, into which blocks stored in a block database (DB) are assembled.

Here, the block DB stores various types of preset blocks. Here, blocks may be downloaded over the Internet.

The 3D image processing method used in the procedure for modeling in a block-type structure is not especially limited. For example, a greedy algorithm, simulated annealing, cellular automata, an evolutionary algorithm, etc. may be used

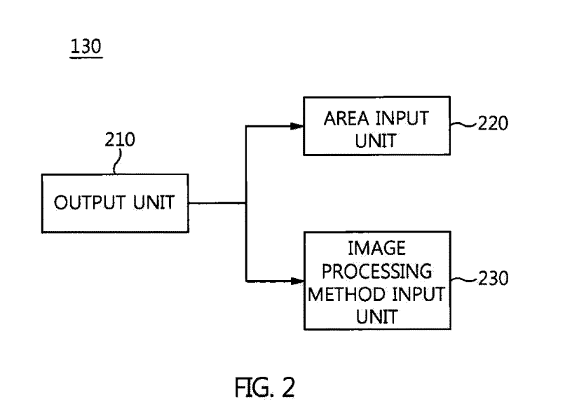

The block-type structure creation unit 120 may transmit information about the modeled block-type structure to the control unit 130 and may modify the block-type structure using the results of feedback from the control unit 130. Further, the block-type structure may be rendered and displayed on the interface. This function will be described in detail later with reference to the following description of the control unit 130 and the description of FIG. 2.

The control unit 130 may perform feedback of the procedure for modeling the block-type structure based on the user's interaction using the interface.

The user may perform interaction with the block-type structure displayed on the interface. The results of interaction may be transmitted to the block-type structure creation unit 120, and then feedback may also be performed during the procedure for creating the block-type structure. For example, the user may perform interaction to set a specific area of the block-type structure displayed on the interface, and to perform a 3D image processing method suitable for the characteristics of the corresponding area

The above example will be described in detail below. That is, it is assumed that there are two methods, that is, 3D image processing method 1, which is a processing method having a high processing speed, but exhibiting slightly low quality, and 3D image processing method 2, which is a processing method having a slightly low processing speed, but exhibiting high quality. Here, 3D image processing method 1 may be applied to a partial area of a block-type structure having a simple shape or having relatively low importance, and thus a block-type structure may be created. Alternatively, 3D image processing method 2 may be applied to an area having a complicated shape or to an important area, and thus a block-type structure may be created. This shows that interaction is possible even in the procedure for creating block-type structures.

The manual output unit 140 may generate a manual required to create the modeled block-type structure by assembling blocks and may output the manual.

Here, the manual output unit is capable of outputting the manual in the format of a video, such as an animation, or allows the manual to be sent and output in the format of a document.

Although not shown in FIG. 1, the apparatus may further include a structure modification unit for modifying the block-type structure by utilizing a sketch that is additionally input using the interface on which the results of rendering the modeled block-type structure are displayed. For example, when a block-type structure representing the torso of a robot created by the block-type structure creation unit 120 is created, arms may be sketched on the torso of the robot displayed on the interface, and then block-type structures related to arms may be created. Here, the torso and arms of the robot may be modeled so that they are easily attachable to each other.

FIG. 2 is a block diagram showing an example of the control unit shown in FIG. 1.

Referring to FIG. 2, the control unit includes an output unit 210, an area input unit 220, and an image processing method input unit 230.

The output unit 210 may render a block-type structure modeled by the block-type structure creation unit 120 and output the rendered block-type structure via the interface. The reason for this is that user interaction for implementing feedback is performed based on the interface, and thus the user interaction is intended to be further facilitated.

The area input unit 220 selects a partial area of the block-type structure displayed on the interface to set the area of the block-type structure on which feedback is to be performed. For example, the user may select a partial area (head) of a block-type structure (robot) displayed on the interface.

Here, the contour of the area selected by the area input unit 220 may be displayed on the interface so that the contour overlaps the block-type structure.

The image processing method input unit 230 sets information about an image processing method for processing the partial area of the block-type structure selected by the area input unit 220.

Here, the image processing method input unit 230 allows the user to select the type of 3D image processing method. For example, the user may select any one of various 3D image processing methods, such as a greedy algorithm, simulated annealing, cellular automata, and an evolutionary algorithm.

The image processing method input unit 230 allows the user to set the parameters required to use the selected 3D image processing method.

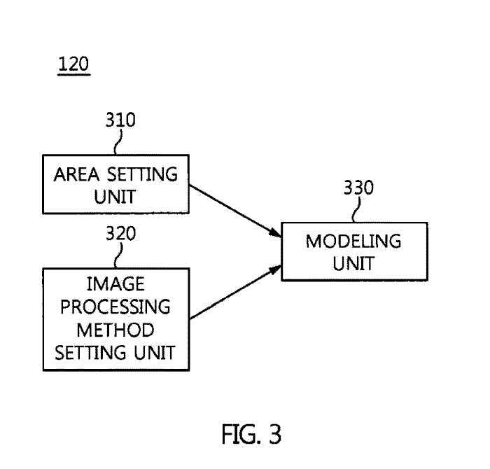

FIG. 3 is a block diagram showing an example of the block-type structure creation unit shown in FIG. 1.

Referring to FIG. 3, the block-type structure creation unit includes an area setting unit 310, an image processing method setting unit 320, and a modeling unit 330.

The area setting unit 310 sets the area in which modeling is to be performed based on the area input by the area input unit 220 included in the control unit 130.

For example, the user may designate the area (i.e. head) of a block-type structure (i.e. robot), input by the area input unit 220, via the interface, and such information may be input to the area setting unit 310 so that modeling may be performed only on the area of the block-type structure (i.e. the head of the robot).

The image processing method setting unit 320 sets an image processing method and parameters to be used for modeling, based on the 3D image processing method and parameters that are input by the image processing method input unit 230 included in the control unit 130.

For example, when a greedy algorithm is selected based on the user interaction by the image processing method input unit 230, modeling is performed using the greedy algorithm if the area (the head of the robot) of the block-type structure designated by the area setting unit 310 is modeled.

The modeling unit 330 performs modeling on the block-type structure based on information set by the area setting unit 310 and the image processing method setting unit 320.

Here, the results of modeling the block-type structure may be transmitted back to the control unit 130. The output unit 210 of the control unit 130 may render the modeling results on the interface, re-output the rendered results, and feed back the rendered results again.

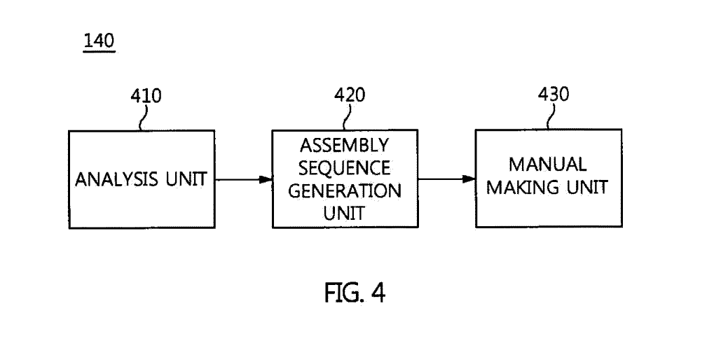

FIG. 4 is a block diagram showing an example of the manual output unit 140 shown in FIG. 1.

Referring to FIG. 4, the manual output unit 140 includes an analysis unit 410, an assembly sequence generation unit 420, and a manual making unit 430.

The analysis unit 410 analyzes the block-type structure modeled by the block-type structure creation unit 120. For example, if there is a block-type structure (robot) composed of 370 A blocks, 123 B blocks, and 22 C blocks, the analysis unit 410 analyzes the block-type structure (robot) as being composed of 370 A blocks, 123 B blocks, and 22 C blocks, and also analyzes assembled portions of the A and B blocks, assembled portions of the A and C blocks, and assembled portions of the B and C blocks.

The assembly sequence generation unit 420 generates the assembly sequence of the block-type structure based on the results of the analysis by the analysis unit 410.

For example, in the case of a block-type structure (robot), the assembly sequence thereof is generated such that it starts at the assembly of A and C blocks present in the arms and terminates at the assembly of B and C blocks present in the head.

The assembly sequence generation unit 420 may select an optimal assembly sequence from among multiple assembly sequences. Here, the optimal assembly sequence may be the fastest assembly sequence that enables blocks to be assembled.

The manual making unit 430 may make a manual based on the assembly sequence generated by the assembly sequence generation unit 420.

The format in which the manual is made by the manual making unit 430 is not limited. For example, the manual may be a document-format assembly manual, an animation-format assembly manual, or a video-format assembly manual.

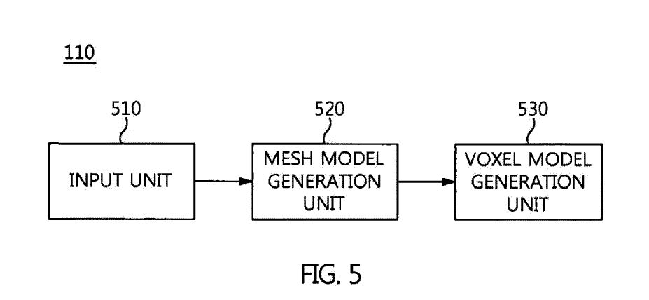

FIG. 5 is a block diagram showing an example of the voxel modeling unit 110 shown in FIG. 1.

Referring to FIG. 5, the voxel modeling unit 110 includes an input unit 510, a mesh model generation unit 520, and a voxel model generation unit 530.

The input unit 510 may receive a user's sketch via an interface.

Here, the tool for receiving the user's sketch is not especially limited. For example, the user may personally make a sketch using a touch screen-based interface. Alternatively, the user may make a sketch on 2D paper, and then the sketch may be received via a scanner.

The user may sketch the entirety of a 3D object having a desired shape, or may gradually sketch the object in stages. For example, when a simple object is sketched, the entire object may be sketched at one time and may be recognized. In contrast, when a complicated object is sketched, the entire object may be divided into several unit partitions, and the respective partitions may be sketched one by one in stages.

The mesh model generation unit 520 may recognize 2D information generated by the user sketching an object, and may convert a 3D model into a 3D mesh model.

Here, the mesh model generation unit 520 may extract the 2D geometric information of the user's sketch by analyzing the sketch, generate a 3D model based on the extracted 2D geometric information, and perform modeling based on the 3D model, thus generating a 3D mesh model.

Here, the 3D model or the 3D mesh model may be rendered and output via the interface, and then the user may modify the model.

Here, when a complicated object is divided into several partitions and the respective partitions are sketched, the partitions may be modeled in respective 3D mesh models and the 3D mesh models may be matched with each other, thus enabling a single 3D model to be generated.

The 3D mesh model obtained via modeling may be rendered and may be displayed to the user via the user interface. In this case, the user may modify the 3D mesh model, generated based on the sketch, using the user interface.

The voxel model generation unit 530 generates a voxel model based on the 3D mesh model. The reason for this is that the inside of the block-type structure is also composed of blocks, and then the block-type structure creation unit 120 must also model the inside of the block-type structure. In this case, the method for generating the voxel model based on the 3D mesh model is not especially limited.

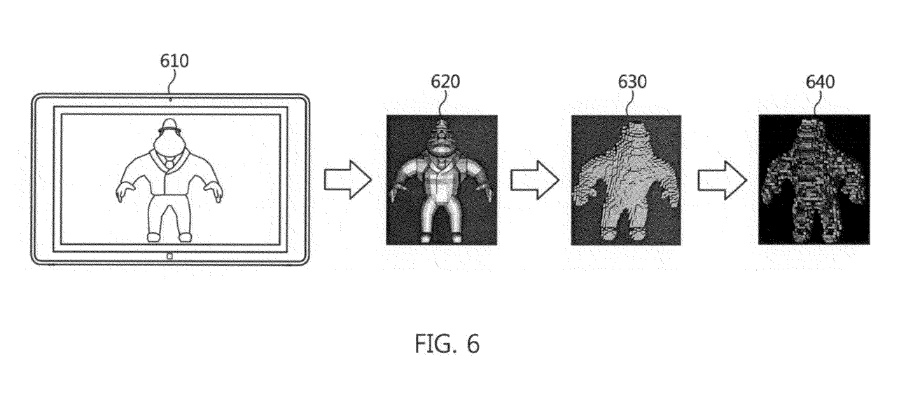

FIG. 6 is a diagram showing examples of input/output of the apparatus for creating a block-type structure using sketch-based user interaction according to an embodiment of the present invention.

Referring to FIG. 6, the forms of input/output include a sketch drawing 610, a voxel model 620, a block-type structure 630, and a block-type structure 640 on which feedback is performed.

The sketch drawing 610 is input via the interface.

Here, the tool for receiving the user's sketch is not especially limited. For example, as shown in FIG. 6, the user may personally make a sketch using a touch screen-based interface. Alternatively, although not shown in FIG. 6, the user may make a sketch on 2D paper, and the sketch may be received via scanning.

The user may sketch the entirety of a 3D object having a desired shape, or may gradually sketch the object in stages. For example, when a simple object is sketched, the entire object may be sketched at one time and may be recognized. In contrast, when a complicated object is sketched, the entire object may be divided into several unit partitions and the respective partitions may be sketched one by one in stages.

A 3D model is converted into a 3D mesh model by recognizing 2D information extracted from the sketch drawing 610, and the voxel model 620 is generated by performing modeling based on the 3D mesh model. The reason for this is that the inside of the block-type structure 630 is also composed of blocks, and thus the block-type structure creation unit 120 must also model the inside of the block-type structure 630, In this case, the method for generating the voxel model 620 using the 3D mesh model is not especially limited.

The block-type structure 630 is created in such a way that the block-type structure creation unit 120 models the voxel model 620 into a block-type structure into which the blocks stored in the block DB are assembled.

Here, the block DB stores various types of preset blocks. Here, the blocks may be downloaded over the Internet.

The 3D image processing method used in the procedure for modeling into the block-type structure 630 is not especially limited. For example, as the 3D image processing method, a greedy algorithm, simulated annealing, cellular automata, an evolutionary algorithm, or the like may be used.

The block-type structure 640 on which feedback is performed is a structure modeled by performing feedback on the block-type structure 630 based on the user interaction.

Here, the control unit 130 performs feedback related to the procedure for modeling the block-type structure 630 based on the user interaction using the interface.

The user may perform interaction with the block-type structure based on the block-type structure 630 displayed on the interface, and the results of interaction may be transmitted to the block-type structure creation unit 120, thus enabling feedback to be applied to the procedure for creating the block-type structure 630. For example, the user may set a specific area of the block-type structure 630 displayed on the interface, and may perform interaction such that a 3D image processing method suitable for the characteristics of the corresponding area is performed.

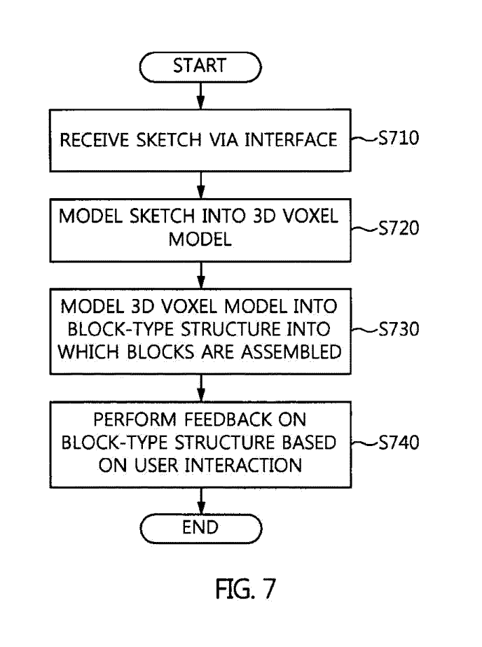

FIG. 7 is an operation flowchart showing a method for creating a block-type structure using sketch-based user interaction according to an embodiment of the present invention.

Referring to FIG. 7, the method for creating a block-type structure using sketch-based user interaction according to the embodiment of the present invention receives a user's sketch via an interface at step S710.

Here, a tool for receiving the user's sketch is not especially limited. For example, the user may personally make a sketch using a touch screen-based interface. Alternatively, the user may make a sketch on 2D paper and then the voxel modeling unit may receive the sketch via scanning.

The user may sketch the entirety of a 3D object having a desired shape, or may gradually sketch the object in stages. For example, when a simple object is sketched, the entire object may be sketched at one time and may be recognized. In contrast, when a complicated object is sketched, the entire object may be divided into several unit partitions and the respective partitions may be sketched one by one in stages.

Further, the sketch is modeled into a 3D voxel model at step S720.

Here, 2D information generated based on the sketch is recognized, and thus a 3D model may be converted into a 3D mesh model. Further, the voxel modeling unit 110 generates a voxel model based on the 3D mesh model. This is because the inside of the block-type structure is also composed of blocks, and the block-type structure creation unit 120 must also model the inside of the block-type structure. In this case, the method for generating the voxel model based on the 3D mesh model is not especially limited.

Further, the 3D voxel model is modeled into a block-type structure into which blocks are assembled at step S730.

Here, the block-type structure creation unit 120 models the voxel model into a block-type structure into which blocks stored in the block DB are assembled.

The block DB stores various types of preset blocks. Here, the blocks may be downloaded over the Internet.

The 3D image processing method used in the procedure for modeling into the block-type structure is not especially limited. For example, a greedy algorithm, simulated annealing, cellular automata, an evolutionary algorithm, or the like may be used.

Here, the block-type structure creation unit 120 may transmit information about the modeled block-type structure to the control unit 130 and may modify the block-type structure using the results of feedback from the control unit 130.

Further, feedback for the block-type structure is performed based on the user interaction at step S740.

In this case, based on the block-type structure displayed on the interface, the user may perform interaction with the block-type structure. The results of interaction may be transmitted to the block-type structure creation unit 120, and then feedback may also be performed during the procedure for creating the block-type structure. For example, the user may perform interaction to set a specific area of the block-type structure displayed on the interface, and to perform a 3D image processing method suitable for the characteristics of the corresponding area

The above example will be described below in detail. That is, it is assumed that there two methods, that is, 3D image processing method 1, which is a processing method having a high processing speed, but exhibiting slightly low quality, and 3D image processing method 2, which is a processing method having a slightly low processing speed, but exhibiting high quality. Here, 3D image processing method 1 may be applied to a partial area of a block-type structure having a simple shape or having relatively low importance, and thus a block-type structure may be created. Alternatively, 3D image processing method 2 may be applied to an area having a complicated shape or to an important area, and thus a block-type structure may be created. This shows that interaction is possible even in the procedure for creating block-type structures.

FIG, 8 is an operation flowchart showing a method for performing feedback on a block-type structure based on user interaction, shown in FIG. 7.

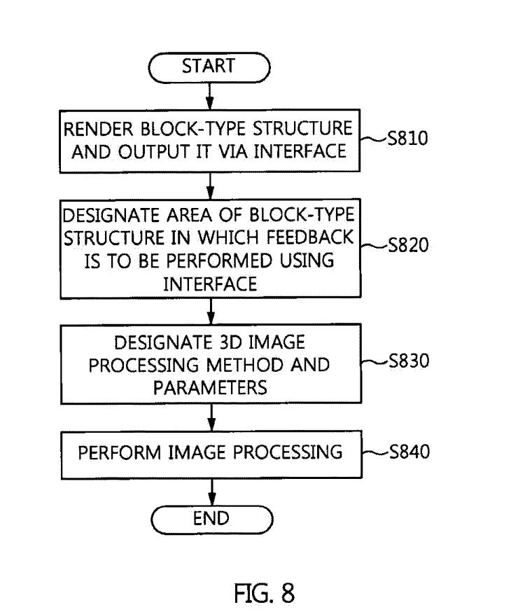

Referring to FIG. 8, the method for performing feedback on a block-type structure based on the user interaction, shown in FIG. 7, first renders the block-type structure and outputs the rendered block-type structure via the interface at step S810. This step is intended to more easily implement user interaction because user interaction for performing feedback is realized based on the interface.

Further, the area of the block-type structure in which feedback is to be performed is designated using the interface at step S820. For example, the user may select a partial area (head) from the block-type structure (robot) displayed on the interface.

The contour of the selected area may be displayed on the interface so as to overlap the block-type structure.

Further, a 3D image processing method and parameters are designated at step S830.

Here, the type of 3D image processing method may be selected by the user. For example, the user may select any one of 3D image processing methods such as a greedy algorithm, simulated annealing, cellular automata, and an evolutionary algorithm.

The image processing method input unit 230 allows the user to set the parameters required to use the selected 3D image processing method.

Further, image processing is performed using the designated area, the designated image processing method, and the set parameters at step S840.

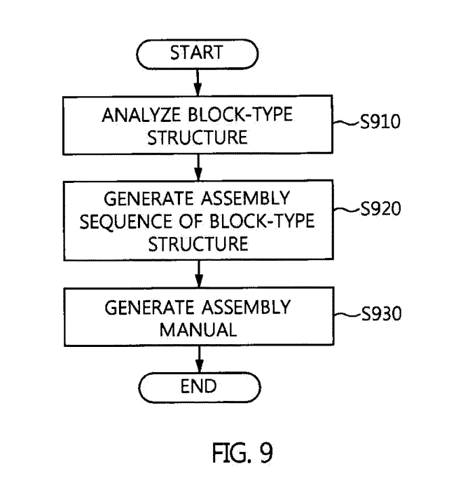

FIG. 9 is an operation flowchart showing a manual generation method performed using the manual output unit 140 shown in FIG. 1.

Referring to FIG. 9, in the manual generation method, performed using the manual output unit 140, the block-type structure is first analyzed at step S910.

Here, the block-type structure modeled by the block-type structure creation unit 120 is analyzed. For example, if there is a block-type structure (robot) composed of 370 A blocks, 123 B blocks, and 22 C blocks, the analysis unit 410 analyzes the block-type structure (robot) as being composed of 370 A blocks, 123 B blocks, and 22 C blocks, and also analyzes assembled portions of the A and B blocks, assembled portions of the A and. C blocks, and assembled portions of the B and C blocks.

Further, the assembly sequence of the block-type structure is generated at step S920.

Here, the assembly sequence of the block-type structure is generated depending on the results of analysis.

For example, in the case of a block-type structure (robot), the assembly sequence thereof is generated such that it starts at the assembly of A and C blocks, present in the arms, and terminates at the assembly of B and C blocks, present in the head.

An optimal assembly sequence may be selected from among multiple assembly sequences, Here, the optimal assembly sequence may be the fastest assembly sequence that enables blocks to be assembled.

Next, an assembly manual is generated based on the assembly sequence at step S930.

Here, the manual is made based on the generated assembly sequence.

The format in which the manual is made is not limited. For example, the manual may be a document-format assembly manual, an animation-format assembly manual, or a video-format assembly manual.

In accordance with the present invention, a task area, the type of 3D image processing technique, and parameters for the 3D image processing technique are set via user interaction, thus enabling a high-quality block-type structure to be created.

Further, the present invention provides an assembly manual for a block-type structure, thus contributing to the faster and easier assembly of a block-type structure using blocks.

Furthermore, the present invention provides an assembly manual for a video-format block-type structure, thus contributing to the faster and easier assembly of a block-type structure.

Furthermore, the present invention enables the selection of different types of 3D image processing techniques, thus enabling a block-type structure to be created faster and more efficiently.

In addition, the present invention provides an intuitive interface based on a sketch, thus enabling a 3D model having a shape desired by a user to be precisely generated.

As described above, in the apparatus and method for creating a block-type structure using sketch-based user interaction according to the present invention, the configurations and schemes in the above-described embodiments are not limitedly applied, and some or all of the above embodiments can be selectively combined and configured so that various modifications are possible.

What is claimed is:

1. An apparatus for creating a block-type structure, comprising:
a voxel modeling unit for modeling a sketch, input via an interface, into a three-dimensional (3D) voxel model;
a block-type structure creation unit for modeling the 3D voxel model into a block-type structure into which blocks stored in a block database are assembled, based on the stored blocks; and
a control unit for performing feedback for a procedure for modeling the block-type structure, based on interaction of a user using the interface.

2. The apparatus of claim 1, wherein the control unit comprises:
an output unit for rendering the modeled block-type structure and outputting a rendered block-type structure via the interface;
an area input unit for selecting, via the interface, an area of the block-type structure in which feedback is to be performed, and transmitting information about the selected area to the block-type structure creation unit; and
an image processing method input unit for receiving a type of 3D image processing method to be used for creation of the block-type structure and one or more of parameters for the 3D image processing method, and transmitting the 3D image processing method and the parameters to the block-type structure creation unit.

3. The apparatus of claim 2, wherein the interface displays a contour of an area including a part of the block-type structure so that the contour overlaps the block-type structure.

4. The apparatus of claim 2, wherein the block-type structure creation unit comprises:
an area setting unit for setting an area in which modeling is to be performed, based on the area selected by the area input unit;
an image processing method setting unit for setting an image processing method to be used for modeling, based on the 3D image processing method and the one or more of the parameters, which are received by the image processing method input unit; and
a modeling unit for modeling the block-type structure, based on information set by the area setting unit and the image processing method setting unit.

5. The apparatus of claim 1, wherein the voxel modeling unit comprises:
an input unit for receiving a model drawn in a sketch mode via the interface;
a mesh model generation unit for generating a 3D mesh model based on the model received via the interface, visualizing the mesh model for the user, and modifying the visualized mesh model; and
a voxel model generation unit for generating the 3D voxel model based on the modified mesh model.

6. The apparatus of claim 1, further comprising a structure modification unit for modifying the block-type structure based on a model that is additionally input in a sketch mode using the interface on which results of rendering the block-type structure are displayed.

7. The apparatus of claim 1, further comprising an output unit for displaying results of rendering one or more of the 3D voxel model and the block-type structure on the interface.

8. The apparatus of claim 1, further comprising a manual output unit for outputting a manual required to create the block-type structure by assembling the blocks.

9. The apparatus of claim 8, wherein the manual output unit comprises:
an analysis unit for analyzing blocks constituting the block-type structure;
an assembly sequence generation unit for generating an assembly sequence of the block-type structure depending on results of analysis; and
a manual making unit for making a manual based on the assembly sequence.

10. The apparatus of claim 8, wherein the manual output unit comprises a video output unit for outputting the manual in a video format.

11. A method for creating a block-type structure, comprising:
modeling a sketch, input via an interface, into a three-dimensional (3D) voxel model;
modeling, based on blocks stored in a block database, the 3D voxel model into a block-type structure into which the blocks are assembled; and
performing feedback for a procedure for modeling the block-type structure, based on an interaction of a user using the interface.

12. The method of claim 11, wherein performing the feedback comprises:
rendering the modeled block-type structure and outputting a rendered block-type structure via the interface so as to perform interaction;
receiving and transmitting a type of 3D image processing method to be used for creation of the block-type structure and one or more of parameters for the 3D image processing method; and
selecting an area of the block-type structure in which the feedback is to be performed using the 3D image processing method via the interface, and transmitting information about the area.

13. The method of claim 12, wherein the interface displays a contour of an area including a part of the block-type structure so that the contour overlaps the block-type structure.

14. The method of claim 12, wherein creating the block-type structure comprises:
setting an area in which modeling is to be performed, based on the selected area;
setting a 3D image processing method to be used for modeling, based on the 3D image processing method and the one or more of the parameters which are received; and
modeling the block-type structure based on set information.

15. The method of claim 11, wherein modeling the sketch into the 3D voxel model comprises:
receiving a model, drawn in a sketch mode, via the interface;
generating a 3D mesh model based on the model received via the interface; and
generating the 3D voxel model based on the 3D mesh model.

16. The method of claim 11, further comprising:
creating the block-type structure by additionally inputting and converting a model in a sketch mode via the interface on which results of rendering the block-type structure are displayed.

17. The method of claim 11, further comprising:
outputting a manual required to create the block-type structure by assembling the blocks.

18. The method of claim 17, wherein outputting the manual comprises:
analyzing blocks constituting the block-type structure;
generating an assembly sequence of the block-type structure depending on results of analysis; and
making a manual based on the assembly sequence.

19. The method of claim 17, wherein outputting the manual comprises outputting the manual in a video format.
